(19) United States
(12) Patent Application Publication
(10) Pub. No.: US 2007/0267493 A1
(43) Pub. Date: Nov. 22, 2007

(54) VOTING SYSTEM AND METHOD

(75) Inventor: McDermot Shafer Coutts, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: INTERNATIONAL LOTTERY & TOTALIZATOR SYSTEMS, INC., Vista, CA (US)

(21) Appl. No.: 11/736,147

(22) Filed: Apr. 17, 2007

Related U.S. Application Data
(60) Provisional application No. 60/747,402, filed on May 16, 2006.

(51) Int. Cl. G07C 13/00

(52) U.S. Cl. 235/386; 705/12

(57) ABSTRACT

A voting system comprises a setup module, which generates a ballot input in a plurality of formats. A conversion module receives the ballot input and generates a converted ballot output. A loading module receives data in the converted ballot output and makes the converted ballot output available to a plurality of precinct modules via a delivery infrastructure. A voting process occurs whereby individuals cast votes using the precinct module and after the votes are cast, the precinct module produce votes outputs based on the converted ballot output and the votes made by the individuals via the voting process. A tabulation module receives the vote outputs from each of the precinct modules and aggregates the vote outputs to produce a result for the election.

### RELATED APPLICATION

The present application claims priority to U.S. Provisional Patent Application Ser. No. 60/747,402 entitled Voting System and Method, filed on May 16, 2006, which is incorporated herein by reference in its entirety.

### BACKGROUND

1. Field of the Invention

The present invention relates to the process of performing an election.

2. Related Art

Voting is a way for an electorate to select among candidates for office. In politics voting is the method by which the electorate of a democracy appoints representatives in its government. A vote, or a ballot, is an individual's act of voting, by which he or she express support or preference for a certain motion, a certain candidate, or a certain selection of candidates. A secret ballot, the standard way to protect voters' political privacy, generally takes place at a polling station.

A voting system specifies the form of the ballot, the set of allowable votes, and the tallying method, an algorithm for determining the outcome. This outcome may be a single winner, or may involve multiple winners such as in the election of a legislative body. The voting system may also specify how voting power is distributed among the voters, and how voters are divided into constituencies whose votes are counted independently.

Electronic voting (also known as e-voting) is a term encompassing several different types of voting, embracing both electronic means of casting a vote and electronic means of counting votes. Electronic voting technology can include punch cards, optical scan voting systems and specialized voting kiosks (including self-contained Direct-recording electronic (DRE) voting systems). It can also involve transmission of ballots and votes via telephones, private computer networks, or the Internet.

Electronic voting, however, is complicated and the process is often not rigorously defined. Oftentimes, electronic voting systems are hard to manage and hard to integrate because they are of different types and are not compatible from one jurisdiction to the next.

Therefore, what is needed is a system and method that reduces or overcomes these significant problems found in the conventional systems as described above.

### SUMMARY

Embodiments described herein are directed to providing a voting system and method. In one aspect, a voting system comprises a setup module, which generates a ballot input in a plurality of formats. One format is a ballot input file, which can be in the extensible markup language (“XML”), for example. The ballot input also can include audio files, such as audio scripts, and printed ballot input, for example in the form of a formatted document.

A conversion module receives the ballot input and generates a converted ballot output, such as data that is capable of being stored in a non-rewriteable storage device, such as a compact disc (“CD”). During the operation of the conversion module 102, the formatted documents can also be transformed into printed ballots, for example by a professional printer.

A loading module receives the converted ballot output and makes the converted ballot output available via a delivery infrastructure to a plurality of precinct modules. The precinct modules request the converted ballot output from the loading module and retrieve the converted ballot output from the loading module via the delivery infrastructure.

A voting process occurs whereby individuals cast votes using the precinct module and after the individuals cast their votes, the precinct module produces vote outputs based on the converted ballot output and the votes made by the individuals via the voting process. A tabulation module receives the vote outputs from each of the precinct modules and aggregates the vote outputs to produce a result for the election. A reporting module can report the election result by printing, publishing, or otherwise presenting the election result in a plurality of manners.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an example of a voting system according to an embodiment of the present invention.

FIG. 2 is a block diagram of an example of a setup module for a voting system according to an embodiment of the present invention.

FIG. 3 is a block diagram of an example of a conversion module for a voting system according to an embodiment of the present invention.

FIG. 4 is a block diagram of an example of a loading module for a voting system according to an embodiment of the present invention.

FIG. 5A is a block diagram of an example of a precinct module for a voting system according to an embodiment of the present invention.

FIG. 5B is a diagram of an example process for voting using the precinct module according to an embodiment of the present invention.

FIG. 6 is a block diagram of an example of a tabulation module for a voting system according to an embodiment of the present invention.

FIG. 7 is a diagram of an example process for utilizing a voting system according to an embodiment of the present invention.

FIG. 8 is a block diagram illustrating an example computer system that may be used in connection with various embodiments described herein.

### DETAILED DESCRIPTION

Certain embodiments as disclosed herein are directed to a voting system and method. After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

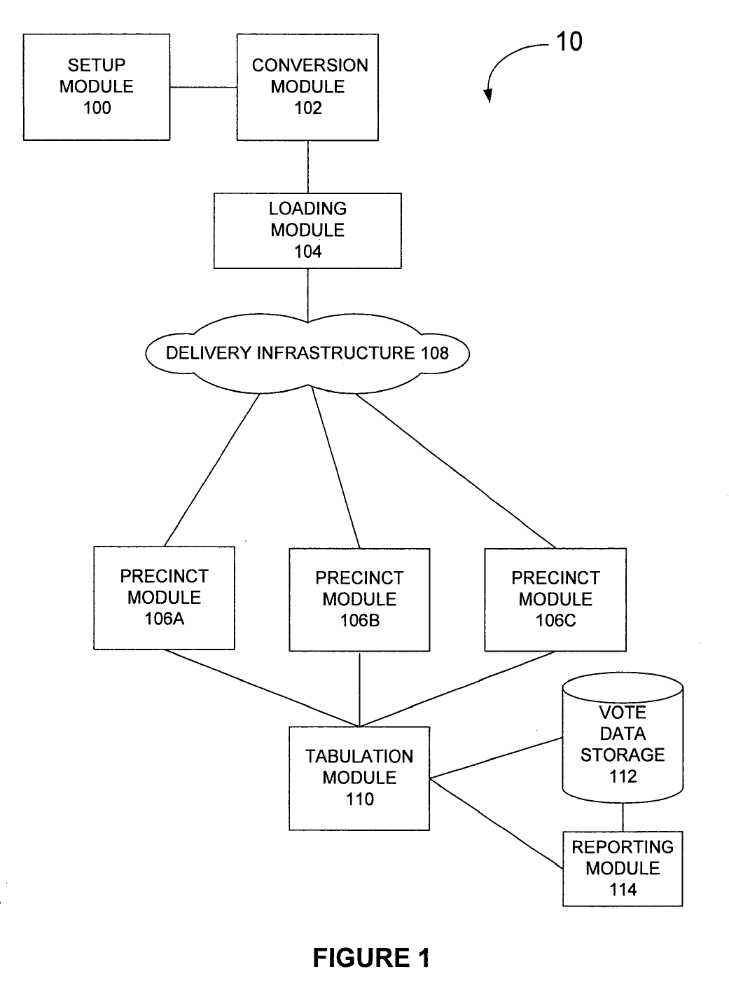

FIG. 1 is a block diagram of a voting system 10 according to one embodiment. The voting system 10 includes a setup module 100, which generates a ballot input in a plurality of formats. One format is a ballot input file, which can be in the extensible markup language (“XML”) format, for example. The XML format for the ballot input file allows for the creation of customized tags to define, transmit, validate and interpret data between applications and between organizations. The ballot input also can include audio files, such as audio scripts. The ballot input also can include printed ballot input in the form of a formatted document, for example in the portable document format (“PDF”).

A conversion 102 module receives the ballot input from the setup module 100 and generates a converted ballot output. In one embodiment, the converted ballot output can be data that is capable of being stored in a non-rewriteable storage device, such as a compact disc (“CD”). During the operation of the conversion module 102, the formatted documents can also be transformed into printed ballots, for example by a professional printer.

A loading module 104 receives the data contained in the converted ballot output from the conversion module 102. The loading module 104 makes the converted ballot output available via a delivery infrastructure 108 to a plurality of precinct modules 106A, 106B, and 106C. Note that there are typically hundreds to thousands of precinct modules in a plurality of precincts, but FIG. 1 only shows three precinct modules for purposes of simplicity. The precinct modules 106A, 106B, and 106C request the converted ballot output from the loading module 104 and retrieve the converted ballot output from the loading module 104 via the delivery infrastructure 108.

A voting process occurs whereby individuals cast votes by interacting with the precinct modules and after the voters cast their votes, each precinct module produces vote outputs based on the converted ballot output and the votes made by the individuals via the voting process. A tabulation module 110 receives the vote outputs from each of the precinct modules and stores the vote outputs in vote data storage 112. The tabulation module 110 receives the vote outputs either electronically, for example via a data bus or network connection, or by a portable memory device in each precinct module, which stores the vote outputs and is physically moved from the precinct module and then coupled to the tabulation module 110. The tabulation module 110 aggregates the vote outputs from the vote data storage 112 to produce a result for the election, which is stored in the vote data storage 112. A reporting module 114 can access the results of the election in the vote data storage 112 and can print, publish, or otherwise present the results in a variety of manners.

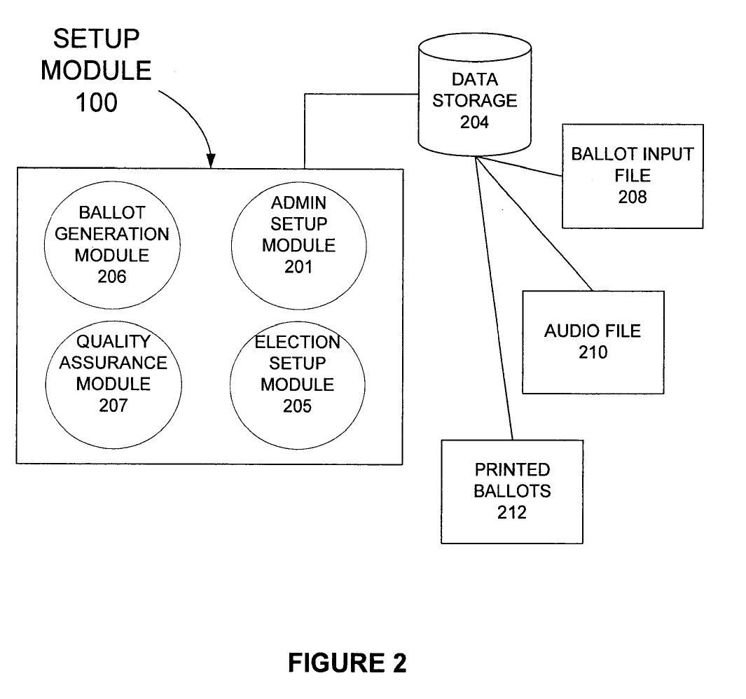

The setup module 100 will now be described in more detail with reference to FIG. 2. The setup module 100 includes an administrative setup module 201, which provides for an administrative setup procedure. In the administrative setup procedure, an authorization process initiates the execution of a ballot generation module 206. The ballot generation module 206 opens a program designed to set up the data storage 204 and configure it for the election. Configuring the data storage 204 includes, for example, setting it up for political parties, district types, languages, etc. The initial setup by the administrative setup module 201 ensures that the election officials have the correct choices for entering data.

The administrative setup module 201 then terminates and the ballot generation module 206 receives new definitions for accounts for election officials who will be using the ballot generation module 206 and any subsequent modules (See, FIG. 1). The ballot generation module 206 is then capable of being logged into by election officials, for example, so that the ballot generation module 206 can receive definitions for a jurisdiction's geographical districts, district offices, and voting precincts.

A quality assurance module 207 works in conjunction with the ballot generation module 206 to enable verification that the political parties, district types, and language choices are correctly set up. To proof the election setup, the quality assurance module 207 allows an election official to produce a ballot generator report.

After the administrative setup procedure, the setup module 100 invokes an election setup module 205 for an election setup process. The election setup process is a process in which the election setup module 205 enables the definition of contests, candidates, measures, and the like, and associates them with districts and precincts. The election setup module 100 enables the determination of the content of the ballots that the ballot generation module 206 will produce. The election setup module 205 typically enables this process before each election.

During the election setup process the ballot generation module 206 receives input election data, which it provides to the data storage 204. Election data includes, for example, the election title, date, contests, candidates, measures, and translations into all of the required languages. The quality assurance module 207 then allows the printing, inspecting, and approving of ballot proofs for each precinct in each language. Then, the ballot generation module 206 outputs a ballot input file 208. The setup module 100 provides the ballot input file 208 as input into the conversion module 102. The ballot input file 208 can be in an XML format or another suitable format, for example.

The quality assurance module 207 also allows for printing and proofing the audio file 210 in all of the required languages. The conversion module 102 receives the audio file 210 as input from the setup module 100. The audio file 210 can be an audio script, for example. The quality assurance module 207 also allows for creating and printing a formatted document, for example a PDF file, for printed ballots 212 in all of the required languages. The conversion module 102 receives the printed ballots 212 from the setup module 100. The printed ballots 212 can be used for professional printing.

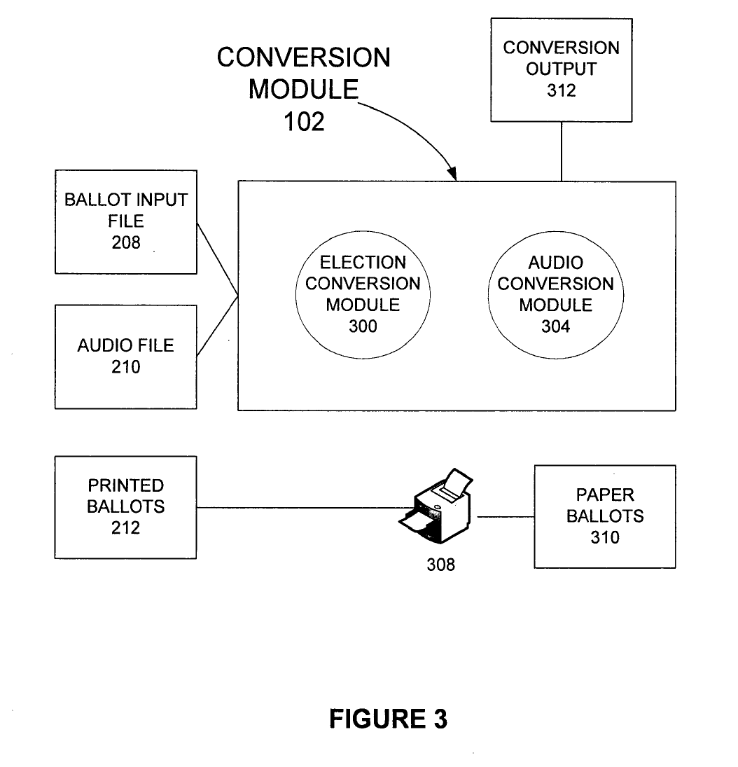

The conversion module 102 will now be described in more detail with reference to FIG. 3. The conversion module 102 performs a process by which it converts inputs and makes adjustments to the inputs before being delivered to and installed on one of the precinct modules 106. The conversion module 102 receives the ballot input file 208 and the audio file 210 from the election setup module 100 either physically or electronically.

One example of the properties of a ballot input file 208 that the election conversion module 300 receives will now be described with respect to Table 1. In XML format, the properties of Table 1 can be hierarchically arranged in an XML tree, as level that branch out from a root XML node.

TABLE 1

| Property | Level | Description |
|---|---|---|
| Root | 1 | Root node for the XML tree. |
| ElectionID | 2 | A system generated ID number that uniquely identifies this |
| | | election. |
| Date | 2 | The date of the election. |
| IsPresidential | 2 | Does this election have separate ballot styles depending on a |
| | | person's party? (Y/N) (can be a Boolean Value). |
| AllowStraightVote | 2 | Is straight party voting allowed in this election? |
| ElectionType | 3 | The type of election (primary, runoff etc). Does not affect the |
| | | display of the election. |
| Jurisdiction | 3 | The name of the county running the election. |
| Title | 3 | The title of the election, generally the Jurisdiction —election type |
| | | and election date. |
| Languages | 3 | The list of languages that are supported by this jurisdiction for |
| | | this election. |
| Default | 4 | The ID of the default language. |
| Language | 5 | A language supported for this election by the system for this |
| | | election. |
| ID | 6 | The ID code of the language that uniquely identifies it in the |
| | | system |
| Name | 7 | The name of the language in the default language. |
| Translation | 7 | The name of the language in its own form. |
| IsImage | 7 | Is this a Unicode language that will require the system to display |
| | | images instead of text? (can be a Boolean Value). |
| Parties | 3 | The list of political parties recognized by this jurisdiction. |
| Party | 4 | A political party that is recognized by this jurisdiction. |
| PartyID | 5 | The unique ID of this party. |
| StraightVoting | 5 | Does this party allow straight voting if it is supported by this |
| | | election? (can be a Boolean Value). |
| PartyName | 6 | The name of the party. |
| PartyAbbrev | 6 | The abbreviation of this party. |
| Contests | 3 | The contests in this election. (can be multiple contests). |
| Contest | 4 | The entry for one particular contest. |
| ContestID | 5 | The system generated unique ID for this contest. |
| ISMeasure | 5 | Is this contest a measure? (Y/N) (can be a Boolean Value). |
| ISRecall | 5 | Is this contest an Recall contest? (Y/N) (can be a Boolean Value). |
| ISInstantRunoff | 5 | Is this contest an instant run off contest? (Y/N) (can be a Boolean |
| | | Value). |
| RunoffLevels | 5 | How many levels are allowed for this instant runoff contest. A |
| | | value of 0 means the voters must rank every candidate. |
| PrecursorID | 5 | If the contest is a recall contest? There may be two parts. (A |
| | | Yes/No and a replacement) |
| AllowStraightVote | 5 | Does this contest allow for a straight party vote where allowed? |
| | | (can be a Boolean Value). |
| AllowWriteIn | 5 | Does this contest allow write ins? (can be a Boolean Value). |
| VoteFor | 5 | Number of candidates that a voter should vote for in this contest. |
| | | (e.g., 1 . . . N). |
| Header | 6 | The header of the contest, generally associated with the district. |
| Title | 6 | The title of the contest. (i.e., office name or proposition name). |
| Description | 6 | The description of the contest. (only used for displaying |
| | | measures). |
| DistrictID | 7 | The ID number of the District that contains this contest. |
| Candidate | 6 | The entry for a particular candidate. (can be multiple candidates). |
| CandidateID | 7 | The system generated unique ID for this candidate. |
| PartyID | 7 | The party ID associated with this candidate. (can be null). |
| Name | 8 | The name of the candidate. (can be Yes or No as well) |
| Description | 8 | The description of the candidate. (i.e., businessman). Not used in |
| | | measures. |
| IsValidWriteIn | 9 | If write in candidates are allowed, is this candidate a valid write |
| | | in? |
| BallotStyles | 3 | Entries for the allowable ballot styles. |
| Ballot Style | 4 | Entry for a particular ballot style. (can be multiple ballot styles). |
| BallotStyleID | 5 | The ID of this ballot style, system generated, it is used to |
| | | associate the ballot style with a precinct portion |
| Ballot | 6 | Ballot Related Information. |
| PartyID | 7 | If the election is ballot by party this would be party ID, for |
| | | general this is 0 for Non-Partisan. |
| ContestOrder | 8 | The order that the contest is displayed, this value is derived for |
| | | each election based on the overall order. (i.e., what order would |
| | | the contests be displayed if they were all in a single ballot style) |
| | | This is used for generating aggregate reports. |
| WriteInPositions | 9 | The positions (if any) used for write in candidates in a comma |
| | | delimited list. |
| ContestID | 9 | The ID of a contest associated with this ballot style and party. |
| Order | 9 | The order in which the contests are displayed. |
| CandidateOrder | 10 | Candidate order information. |
| CandidateID | 11 | Candidate ID for the candidates associated with this contest in |
| | | this ballot style. |
| Order | 11 | The order in which the candidates are display for this ballot style. |
| Position | 11 | The physical position on the card, which corresponds to the |
| | | candidate for this ballot style. |
| Precincts | 3 | Information related to the precincts. |
| Precinct | 4 | Entries for a particular precinct. |
| PrecinctID | 5 | The system generated value that uniquely identifies this precinct- |
| | | portion to the system. |
| IsKey | 5 | If there are multiple precincts with the same ballot style this is the |
| | | precinct that they get reported under. Totals must be aggregate. |
| Precinct | 6 | The ID number assigned to this precinct by the jurisdiction, if this |
| | | is a split, this number refers to the parent precinct. |
| Portion | 6 | If the precinct is split into portions, this is the portion ID |
| | | associated with this unique precinct ID. The portion is a number. |
| | | If there is not split or precinct is a parent, the value is 0. |
| PrecinctName | 6 | The name of this precinct, as it is know by the jurisdiction. |
| BallotStyleID | 6 | The ballot style that is associated to this precinct for the current |
| | | election. |

A professional printer 308 receives the printed ballots 212. The professional printer 308 generates a paper ballot 310. The conversion module 102 further provides the audio files 210 (e.g., audio scripts) to an audio conversion module 304. The audio conversion module 304 transforms the audio file into a sound file of the appropriate format for the election in all languages. The sound files can be waveform audio files (“WAV”), motion pictures expert group files (“MPEG”), audio video interleave files (“AVI”), MPEG layer 3 files (“MP3”), or similar files for each audio script.

The election conversion module 300 receives the sound files from the audio conversion module 304 via an upload process. The election conversion module 300 tests the sound files and enables the sound files to be accepted, after which they are ready for the election. The conversion module 102 stores the sound files in the form of conversion output 312, which may reside on a CD or another suitable memory device. In one embodiment, the memory device is not rewriteable for security purposes.

In one embodiment, the election conversion module 102 transforms the XML data in the ballot input file 208 to a format suitable for the precinct modules 106 and converts it to the conversion output 312. This includes, for example, determining what portions of the ballot input file 208 the precinct module 106 needs and splitting the ballot input file 208 into multiple definition files so that the precinct module 106 does not hold any more data in its memory than necessary. This also includes, for example, applying an election specific security policy to the data that is transformed into the conversion output 312, including assigning an election specific encryption key to the definition file data.

The conversion module 102 enables adjustments to be made as needed to the election using the election conversion module 300. Typically at this point the election conversion module 300 enables proofing of the ballots, but the ballots cannot be changed. To perform such changes, the conversion module 102 typically returns the ballot input file 208 to the ballot generation module 206.

The conversion module 102 can also receive definitions for election officials who the loading module 104 and/or the tabulation module 110 will allow access following the election, for example to upload votes or so that the reporting module 114 can produce election results. The conversion module 102 can also receive definitions regarding specific options for a precinct module 106.

After the conversion module 102 completes operation, it produces the conversion output 312. The conversion output 312 includes ballot data on CD or other non-rewriteable memory device. In one embodiment, the conversion output 312 includes two encrypted zip files. One file contains the election definition files and the other file contains the audio files. A checksum file may also be included, which is used to validate the other two files.

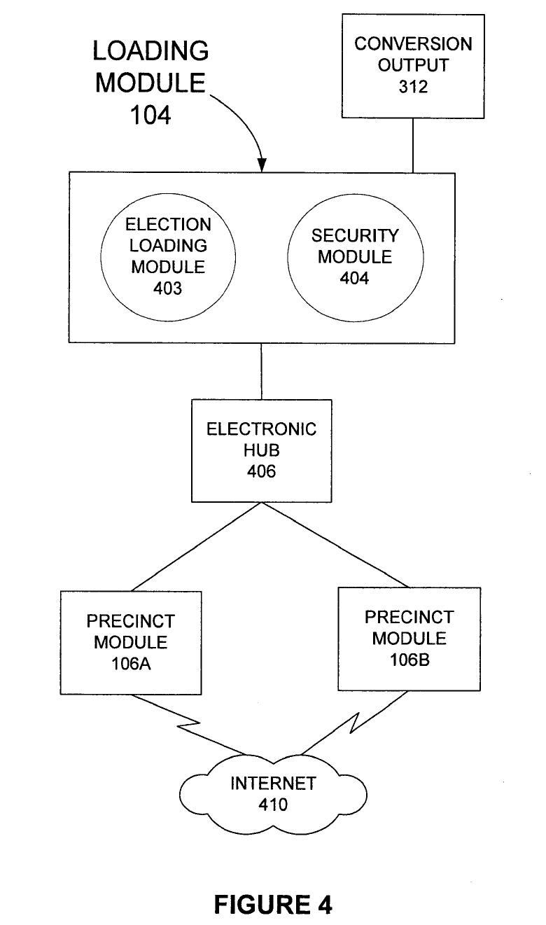

The loading module 104 will now be described in more detail with reference to FIG. 4. Election loading using the loading module 104 typically takes place at an election warehouse or another secure location. The loading module 104 receives the conversion output 312 from the conversion module 102. The loading module 104 is responsible for making the conversion output 312 available to the precinct modules 106A and 106B, wherein the precinct modules 106A and 106B can request and retrieve the conversion output 312 from the loading module 104.

The loading module 104 includes an election loading module 403, which is configured to receive the conversion output 312. In one embodiment, the loading module 403 is a Windows-based PC that makes encrypted election data from conversion output 312 available to the precinct modules 106A and 106B. In another embodiment, the conversion output 312 includes an election “manifest” properties file that sets options and directs the precinct modules 106A and 106B to all of the files it should load. This includes files associated with, for example, election title and date (the date determines whether voting can be opened); election contests, candidates, candidate rotation, and other election information; ballot styles, precincts, and precinct IDs; jurisdiction parameter settings for the election; valid maintenance passwords (encrypted); election security keys (encrypted); and audio files for audio ballots.

The precinct modules 106A and 106B pull the conversion output 312 from the loading module 104 when the precinct modules 106A and 106B are activated. More specifically, the loading module 104 operates as follows. First, the election loading module 403 begins executing. Then, the precinct modules 106A and 106B are activated. The election begins loading and the precinct modules 106A and 106B pull the conversion output 312 (election data) through an electronic hub 406 from the election loading module 403. The electronic hub 406 can be, for example, a local area network (LAN) hub with multiple ports.

In one embodiment, each precinct module 106A and 106B makes a hyper-text transfer protocol (“http”) request to a specified Internet Protocol (“IP”) address via the Internet 410 to retrieve the manifest file. The precinct modules 106A and 106B use the manifest file to download election data components to appropriate locations onto its memory (e.g., hard disk drive).

In one embodiment, the loading module 104 includes a security module 404. The loading module 104 uses the security module 404 when the election loading module 403 is transferring the conversion output 312 to the precinct modules 106A and 106B. The security module 404 may implement one or more of the following security precautions:

The security module 404 can verify and ensure that the delivery infrastructure 108 is a dedicated network. The security module 404 can ensure that the voting system 10 only allows access to authorized election officials. The security module 404 can require a password to start the election loading module 403. The security module 404 can require a maintenance password at each of the precinct modules 106A and 106B. The security module 404 can require the precinct modules 106A and 106B to access the manifest properties file with a specific security key during the operation of the election loading module 403. The security module 404 can require election data on the election loading module 403 to be encrypted and zipped. The security module 404 can ensure that the election loading module 403 has no network connections other than to the electronic hub 406. The security module 404 can also ensure that the precinct modules 106A and 106B are unable to make network connections other than the one to download election data. (i.e., telnet, file transfer protocol (“FTP”), and operating system functions are inaccessible to normal users.)

Although some of the security features of the present voting system 10 are shown as being contained in or implemented by the security module 404. Some features and others can be implemented elsewhere as a general security policy for the entire voting system. In that respect, the security policy can be implemented in one or all of the setup module 100, the conversion module 102, the loading module 104, the precinct modules 106, or the tabulation module 110.

Each precinct module 106A or 106B that successfully loads the conversion output 312 provides the election loading module 403 with its internal machine name and identification that it loaded the conversion output 312. The precinct modules 106A and 106B can also return an indication of unsuccessful attempts at loading the conversion output 312. The information can be used as a record of conversion output 312 loading activity on one of the specific precinct modules 106A or 106B.

The precinct module 106A and/or 106B can receive requests to test the installation by printing a “zero count” report for all of the selected precincts, showing the contests and candidates as they appear on the ballot. The precinct modules 106A and/or 106B can also receive requests for performance of logic and hardware diagnostic testing. The precinct modules 106A and 106B are then packaged and prepared for delivery to the precinct polling locations.

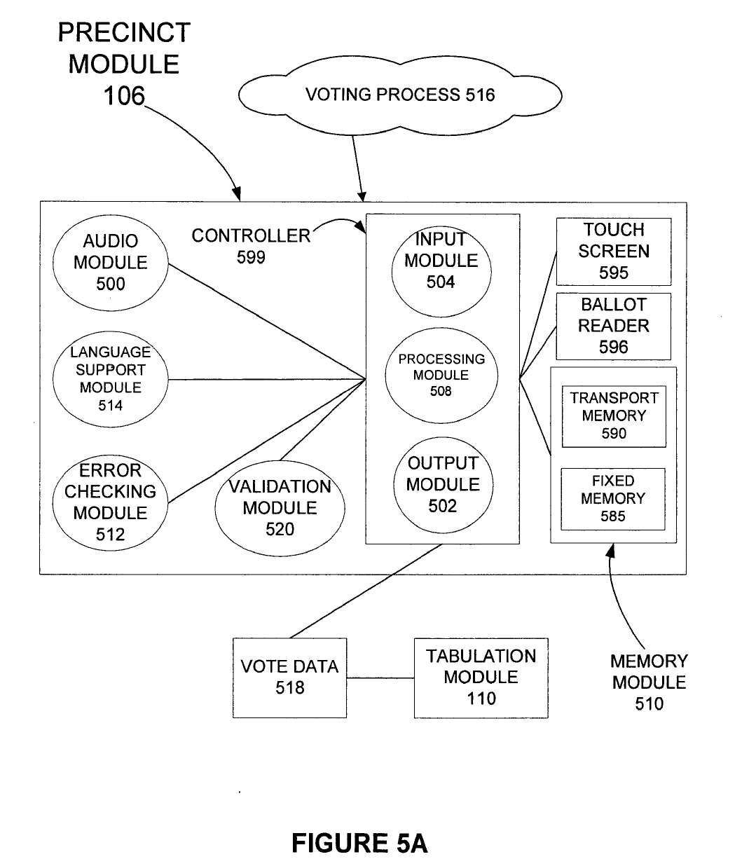

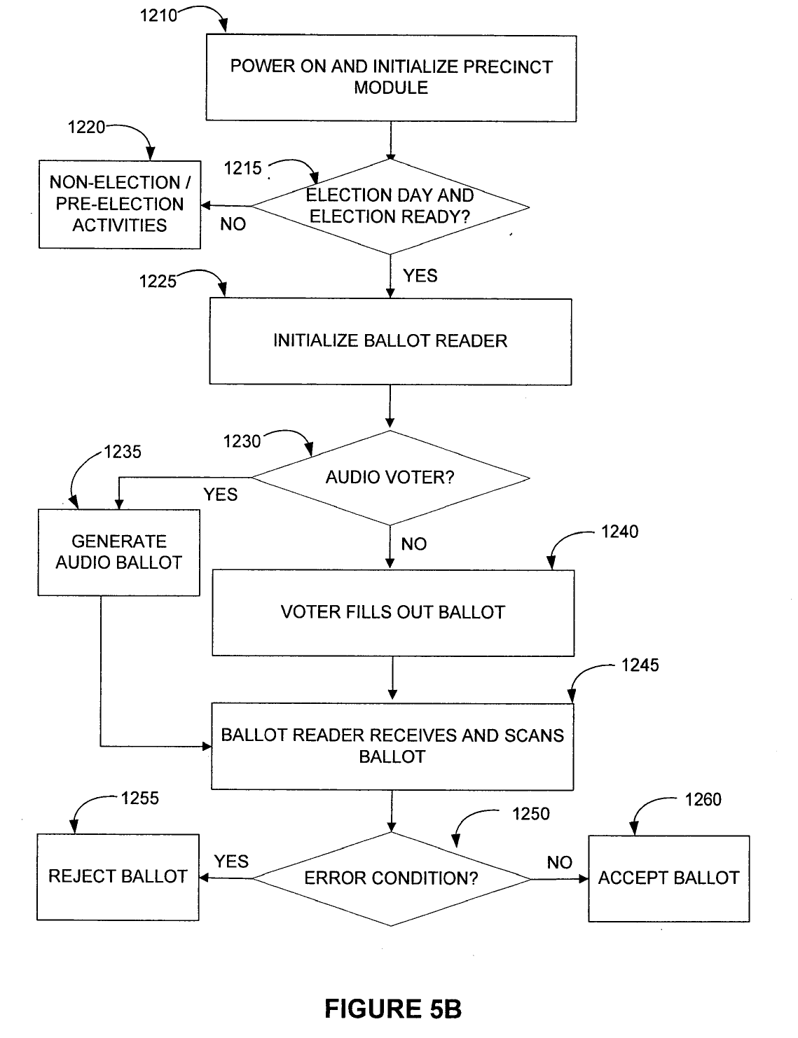

Once the precinct modules 106A and 106B are delivered to precinct polling locations, voting can occur. One precinct module 106 will now be described in more detail with reference to FIG. 5A. The precinct module 106 includes a controller 599. The controller 599 includes an input module 504, an output module 502, and a processing module 508. In one embodiment, the controller 599 is a Linux-based desktop computer coupled to a touch screen display 595. The touch screen display 595 can be a display screen such as a liquid crystal display (“LCD”). The LCD displays the applications and enables the administration and management of a voting process 516. (The voting process will be described in further detail in FIG. 5B.)

Each component of the controller 599 can be uniquely identified for tracking purposes. The controller 599 controls and monitors all components of the precinct module 106. In one embodiment, a memory module 510 provides two applications to the controller 599, a maintenance application requiring a maintenance password, and an election application that executes when the voting process 516 is scheduled to occur.

The processing module 508 can include any processor capable of carrying out and executing the instructions needed to operate the precinct module 106. The processing module 508 is capable of processing different types of election schemes, including general elections, closed primaries, open primaries, modified open primaries, primary presidential delegation nominations (handled by multiple selection contests), cross-over (Decline to State) primary voting, combined state primary and county general elections, recall issues, with or without replacement options, partisan offices, non-partisan offices, run-off elections, multiple selection contests: vote for N of M, measures, propositions, questions, retentions, write-in voting (audio ballot), single (consolidated, clustered) and split precincts, ballot rotation, straight ticket voting, electronic counting and tracking of provisional, absentee, and recount ballots, for example.

On election day and when the precinct module 106 is ready, the precinct module 106 receives the ballots as input and enables the voters to cast a vote. For example, voters can mark ballot selections in ink on ballot cards, or listen to audio ballots and print slips containing their selections. The input module 504 may be connected to an area such as a ballot reader 596 where the precinct module 106 receives the input ballot via insertion or scanning. The input module 504 can also receive votes by reading input from keystrokes, touches on a screen, or other suitable input.

In another embodiment, the ballot reader 596 is an optical mark reader connected directly to the controller 599 to read marked selections on ballot cards. The ballot reader 596 validates each ballot card inserted for overvotes and, if selected, undervotes. It then passes the voter selection information to a precinct server. The application converts selections to candidate IDs and records the cast vote. After being read, the ballot reader 596 ejects each ballot card into an attached, sealed ballot box.

In one embodiment, the security policy is implemented with respect to the precinct modules 106. In this example, the controller 599 is partitioned into a client device and a server. The election application uses encryption and executes on the client device. The voter casts votes on the client device. The client device connects to the server where a vote file and any election results reside. The client device can display the vote file via the touch screen 595 only when the server allows it to do so. Otherwise, the client device cannot access the vote files. In one example, the security policy only allows one election official to access the vote files on the server. In another example, the controller is a Linux system and permissions are set for the vote files such that the server has read and write permission and the client only has read permission.

In one embodiment, the precinct module 106 includes a validation module 520. The validation module 520 ensures that any software resident in the memory module 510 is expected software. The validation module 520 examines all software in the memory module 510 and makes a determination as to whether the software under examination is expected software. If the software is expected, the validation module 520 allows the software to execute. If the software is not expected and the validation fails, the validation module 520 does not allow voting to occur on the precinct module 106.

In another embodiment, the ballot reader 596 is an optical mark reader, which communicates with a Java application. The ballot reader 596 reads data on clock marks, and both sides of a ballot card, right side up or upside down. When the precinct module 106 is powered on, the ballot reader 596 is configured to power on also, and it powers on “disabled” so that the software can enable and control the card feed. If it is not election day and a demonstration is not loaded, and a logic test has not been selected, a client application in the precinct module 106 will not access or activate the ballot reader 596 (except for diagnostic testing). If it is election day (or a demonstration or logic test), the ballot reader 596 may receive a card in a bezel on the precinct module 106 that leads to the ballot reader 596. The ballot reader 596 draws the card in and scans it, and it either ejects it into the ballot box (accepted) or sends it back out to the voter (rejected).

A reader status area on the touch screen 595 can display the current status of the ballot reader 596. The reader status area displays one of the following status indicators. The touch screen 595 displays the status messages while the status is active: 1) ready—the ballot reader 596 is ready to receive a ballot card; 2) reading—the ballot reader 596 is currently reading a ballot card; 3) recording—the data from the ballot card is being cast as a valid ballot; 4) invalid—there were alert conditions found during validation of the vote data; 5) remove card—a card is inserted and another card is currently being read; 6) jammed—the ballot card is jammed in the reader mechanism; 7) no reader—the reader hardware is not detected; and 8) closed—voting is not open.

In one embodiment, the ballot reader 596 has a number of buttons. The ballot reader 596 may include an override button, which is enabled when a ballot has alerts and is used to cast a ballot by ignoring incorrect marks on the ballot card. The button is checked when override is selected (turned on) and unchecked immediately after reading the card. The ballot reader 596 also has a validate only button, which validates an inserted ballot card and then ejects it out the front to the voter without casting the ballot. The button is checked when selected (turned on) and unchecked immediately after reading the card. The ballot reader 596 also has a print button, which it enables when a ballot alert or transaction receipt is available for printing. The print button is used to print a ballot alert or transaction receipt on demand.

Additionally, the output module 502 may process additional messages to the touch screen 596 regarding the ballot reader 596. The messages include: 1) ballot alert—overvotes and/or undervotes or no selections exist on the ballot (the output module 502 can print a report for the voter); 2) invalid ballot card—the card is invalid, not the right type (for example, the ballot reader 596 received an absentee card when the precinct module 106 is in normal mode) or does not belong to any known precinct; 3) invalid ballot style—the card has not been initialized on the precinct module 106 and the parameter to initialize new ballot styles after voting begins is not set; 4) provisional audio ballot—the audio ballot was issued out of precinct and the printed audio ballot slip must be cast as “provisional”; and 5) cast ballot successful—the ballot was cast. The current message is displayed until the ballot reader 596 receives another ballot.

The audio ballot module 500 processes votes for the visually impaired. The touch screen 595 uses the audio ballot module 500 to display the status of the audio ballot voting. The audio ballot status area changes when a new event takes place and may display one of the following status indicators: 1) available—the audio ballot module 500 is available for use; 2) retrieving—the audio ballot module 500 is retrieving the ballot for the voter; 3) ready—the audio ballot module 500 has retrieved the ballot for the voter and is ready for use; 4) no contest—there are no contests to vote on for the selected precinct (the audio ballot will not run); 5) active—a voter is currently voting with the audio ballot module 500; 6) printing—the output module 502 (e.g., a ballot printer) is printing a voter's audio ballot slip; 7) printed—the output module 502 has printed the audio ballot; 8) closed—voting is not open; 9) not connected—the ballot printer is not found on startup (voting at the ballot reader 596 may begin. A check printer button is activated when this status appears to recheck the connection status after adjustments have been made); 9) check printer—the ballot printer is not found when start is pressed, or when the voter presses the select keyboard key to print the ballot (ballot reader voting may continue). The status automatically returns to the previous normal status when the problem has been fixed.

The input module 504 also contains buttons in an audio ballot section. In one embodiment, buttons in the audio ballot section include the following: 1) a start button starts an audio ballot session. (as soon as a session is started, the button is removed); 2) a check printer button appears if “not connected” status appears. (an election official attempts to solve the printer problem and then presses this button. Check printer causes the controller 599 to check again for the existence of the ballot printer and, if it finds the ballot printer, it initializes the printer, returns the status to “available,” and changes the button back to start); 3) a cancel button appears when the audio ballot process has begun-stops and clears the session (return to start button only); 4) a play audio appears when all audio ballot prompts are answered. (It starts the audio ballot sound when the voter is ready to begin and appears with cancel and is disabled while the audio ballot plays.)

A parameter in the precinct module 106 can be set to cause the language module 514 to enable the use of multiple languages. A parameter to use a print button for ballot alert reports is automatically enabled in this case. If the ballot alert is set to print automatically by parameter, a default English report prints first. The print button may then be activated to display a language selection screen on the touch screen 595 and select the voter's language. The report prints in the selected language. The system returns to the default language (English) after the report is printed.

When an election has multiple languages, the language module 514 receives a selection of the appropriate language for the voter to setup audio announcements. A language selection screen appears in a selection screen. The language selection screen appears if there is more than one language supported by the system. If language selection is not needed, the screen does not appear. The audio ballot section includes a cancel button to allow exit of the audio ballot process. The language is selected from the touch screen 595 and immediately returns to the main selection screen.

The precinct module 106 stores an electronic form of each ballot, which is used to record, tally, and report on the paper ballots that the input module 504 reads. Cast ballots receive a code marking them as normal, override (the override function was selected) or audio (for an audio ballot). In one embodiment, before the vote is cast, the controller 599 writes data from the ballot to two storage devices in the memory module 510, one of which is a transport memory 590 and another of which is a fixed memory 585 (e.g., a hard disk drive storage device). This redundancy ensures accurate recovery from the transport memory 590 in the event of a system failure while the precinct module 106 is reading a ballot.

To ensure security and accuracy, a checksum of the vote file (audit trail) occurs when the controller 599 accesses the memory module 510. All cast ballots, and all read and write actions can be recorded in a self-auditing administrative log. Audio ballot voters can also insert audio ballot receipts into the input module 504 to cast a vote. When using an audio ballot, the input module 504 may also include an Americans with Disabilities Act (“ADA”) compliant unit, such as a keyboard used to navigate the audio ballot.

An error checking module 512 is capable of checking for errors that are input by the voters into the input module 504, including for example, automatic checking and notification of overvote conditions, optional checking and notification of undervote conditions, and optional checking and notification of undervotes for specific contests. For example, the error checking module 512 can enable the output module 502 to record overvotes on a ballot as “no selection” for the contest and can mark the contest with an overvote value. The error checking module 512 can enable the output module 502 to record elections on undervoted contests and note the undervote.

When all voting activities are finished, voting on the precinct module 106 is closed and the output module 502 prints an election summary. The precinct module 106 is then turned off and it transmits data containing voting files from the memory module 510 (usually the transport memory 590) to the vote data 518. The transport memory 590 can be a portable memory, such as a USB device, for example, and in that respect, the vote data 518 can be physically removed from the precinct module 106. Alternatively, the fixed memory 585 can facilitate the removal of the data from the memory module 510 via a bus, for example. The precinct module 106 can then be packaged and returned to voting headquarters or other another suitable location.

If there is a question concerning the previous election and if the voting data still exists on the precinct module 106, the output module 502 can print an audit trail. The audit trail can record all ballot images. The audit trail function can retrieve the vote file from the memory module 510 and print a ballot image of all the votes cast. Ballot images can be randomized by the processing module 508 for the report. The ballot images can be printed in one contiguous printing operation without cutting between the images.

The maintenance application provides a set of hardware diagnostics to assist in diagnosing and troubleshooting any problems with the precinct module 106. In one embodiment, the following tests are available: a printer test, a ballot printer test, a touch screen test, a display test, a keyboard test, an audio test, and a reader test.

The printer test tests the printer used by the output module 502 to print receipts and reports. When a test print button receives input, it prints a sample with all characters, fonts, and logos across the full width of the paper. It may include a graphic image at the top of the test receipt. A cutting mechanism can cut the receipt to test its functionality.

The ballot printer test tests the audio ballot printer. When a test ballot print button receives input, it prints a sample audio ballot slip. This slip includes text at the top where write-in candidates would be printed (no text in the clock mark row), clock marks, and sample vote data. The cutting mechanism can cut the slip to test its functionality. The ballot reader 596 can receive the slip to verify that it can read the sample ballot.

A touch screen test verifies that the touch screen 595 is working accurately. When a test touch screen button receives input a test screen is presented. The touch screen 595 enables the touching of various spots on the screen, and the touch screen 595 displays points or lines representing the pixels activated by the touch. When an exit button receives input it causes the precinct module 106 to leave the test and return to a diagnostics menu.

A display test checks the system colors for the output module 502. When a test display button receives input, a simple color display appears allowing the technician to determine if the display colors are functioning. When an exit button receives input it causes the precinct module 106 to leave the test and return to the diagnostics menu.

A reader test tests the capability of the ballot reader 596 for reading marks and ejecting the ballot card correctly. If voting is open, the maintenance diagnostics menu disables a test reader button. When the test reader button is enabled and receives input, it generates a prompt and the ballot reader 596 waits to receive a “pattern card.” When the ballot reader 596 receives the insertion of the pattern card, the ballot reader 596 reads the marks and ejects the card. A grid panel similar to the inserted ballot card appears on the touch screen 595 with the card's selections marked. Subsequently inserted cards are matched against the first pattern card. Selections marked on any card inserted (matching or not matching) are shown on the touch screen 595, in order to test the accuracy of the ballot reader 596 and to determine if it is functioning correctly. When an exit button receives input it causes the precinct module 106 to leave the test and return to the diagnostics menu.

A keyboard test checks the audio ballot keyboard. A test keyboard button is disabled if the audio ballot system is being used. When the test keyboard button is enabled and receives input, it displays a graphical keyboard on the touch screen 595. In one embodiment, a 5-key audio ballot keyboard may then receive input. The corresponding key on the touch screen keyboard should appear on the touch screen 595 as pressed, allowing a determination to be made that the keyboard is functioning. The onscreen “pressed” key is deselected when another keyboard key is pressed. When an exit button receives input it causes the precinct module 106 to leave the test and return to the diagnostics menu.

An audio test tests the headphone function in the output module 502. An audio test button is disabled if a voter is using the audio ballot system. When the audio test button is enabled and receives input, it plays a short sound file. When an exit button receives input it causes the precinct module 106 to leave the test and return to the diagnostics menu.

After voting has been closed, the precinct module 106 is shut down and in one embodiment the transport memory 590 is removed. In one embodiment, the transport memory 590 and signed election summary reports are then packaged and delivered to election headquarters or to a central station for uploading to the tabulation module 110. In another embodiment, the vote data is transferred electronically (via a network) directly from the memory module 510 to the tabulation module 110.

The voting process 516 that occurs on the precinct module 106 will now be described in FIG. 5B. FIG. 5B is a diagram of an example process for voting according to an embodiment of the present invention. First, at step 1210 the precinct module 106 is powered on and the precinct module 106 is initialized, for example by receiving a ballot header card. When the precinct module 106 is powered on, it may undergo a sequence of checks and events that determine what the precinct module 106 displays on startup.

The sequence of checks and events causes the precinct module 106 to generally determine at step 1215 that it is either election day and it is ready or it is either not election day and/or it is not ready. If it is not election day or the precinct module 106 is not ready, then non-election or pre-election activities take place at step 1220. For example, the precinct module 106 may check for vote file status, which might indicate that the present election is a demonstration or the precinct module has encountered an error in which case step 1220 occurs. (i.e., in an error condition, the precinct module 106 recovers to the last known voting state.

In one embodiment, the precinct module 106 checks for a demonstration via a flag in a currently installed XML file, which indicates that the election is a demonstration. If the flag is set, the election application opens from the memory module 510 without a date check (as if it were election day). The precinct module 106 then displays a software version, election, and recovery information and step 1220 occurs.

If it is not an election day (and the election loading module 403 is connected) the precinct module 106 displays a maintenance password entry screen providing access to either a maintenance application or a logic test (which will open the election application using currently installed election data) during step 1220. If an election loading module 403 is connected at startup via the electronic hub 406 and a new election file exists (one currently not installed on the precinct module 106) the precinct module 106 begins a load election process during step 1220. If the election loading module 403 is offering the same election ID and election version that is already on the precinct module 106, then the election will not load and the maintenance password screen is displayed at step 1220 as described above.

If a demonstration is not loaded, the precinct module 106 checks the date. If it is a valid election day, as set by the XML file, and all other factors indicate that this is a real election, the precinct module 106 starts the election application and initializes the ballot reader at step 1225. Then, at step 1230, the precinct module determines whether the current voter is an audio voter, for example by receiving input from the input module 504. If the current voter is an audio voter, the audio voter casts their vote audibly. Then, the precinct module 106 generates and prints a ballot at step 1235 based on the audio voter's responses.

If the voter is not an audio voter, the voter fills out their ballot at step 1240. Thereafter, or after step 1235, the ballot reader receives the ballot at step 1245. The ballot reader draws the ballot in, by insertion or scanning for example, and processes it. The ballot reader detects at step 1250 whether there is an error condition (e.g., overvotes, undervotes, etc.) If there is an error condition, the ballot reader rejects the ballot at step 1255, for example by ejecting it back to the voter. Otherwise, the ballot reader accepts the ballot at step 1260, for example by ejecting it into a sealed ballot box. After all voters in the precinct vote using the precinct module 106, the voting is closed and the tabulation module 110 tabulates the votes.

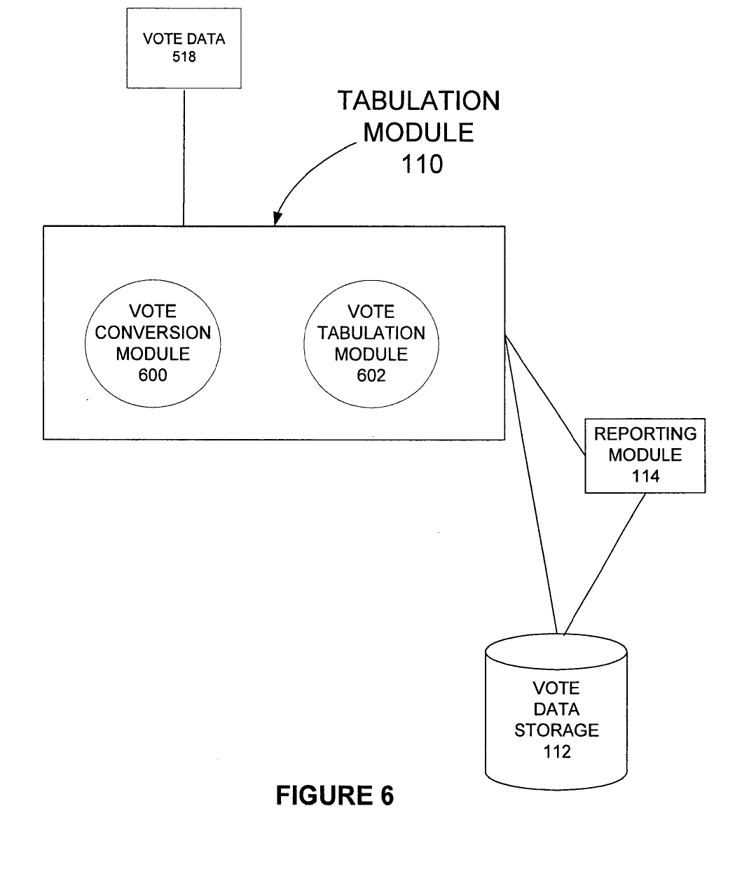

The tabulation module 110 will now be described in more detail with reference to FIG. 6. The vote data 518 provides input to the tabulation module 110. The tabulation module 110 includes a vote conversion module 600 and a vote tabulation module 602. The vote conversion module 600 and the vote tabulation module 602 can reside on the same or a different computing device.

The tabulation module 110 can process absentee, provisional, and recount ballots in different voting modes. The vote tabulation module 602 can be set to a live election or a recount depending on the circumstance. In one embodiment, the vote conversion module 600 receives the vote data 518, for example via a network, a CD, a USB port, or another input port, and monitors the upload of the vote data 518. The vote conversion module 600 reads, uploads, and decrypts the vote files.

In one embodiment, the vote conversion module 600 strips out election specific encryption from the vote data 518 and can perform validation to ensure that the vote data 518 has not been tampered with.

The vote conversion module 600 sends a notification to the vote tabulation module 602 once it uploads the vote data 518. The vote tabulation module 602 then stores the vote data 518 in the vote data storage 112 and updates tables in the vote data storage 112 for reporting by the reporting module 114. The vote tabulation module 602 enables monitoring as the process occurs. The vote tabulation module 602 can display, save, and print the available unofficial reports on request. At the end of the election, the reporting module 114 can produce an official statement of the vote 114.

Although the present voting system 10 is shown as having one tabulation module 110 with one vote conversion module 600 and one tabulation module 602, the voting system 10 also supports a distributed system wherein there may be a plurality of such modules. For example, a plurality of vote conversion modules may upload summary data and ballot images to a central tabulation module and then to the reporting module 114. Similarly, the transport memory 590 having the election results from the precinct module 106 can be brought to any of the vote conversion modules, which can strip out election specific encryption (e.g., encryption specific to a certain precinct module 106) and upload the data to a central tabulation module via a secure protocol, such as https. The central tabulation module can keep track of which precinct module's data has already been uploaded to avoid duplication.

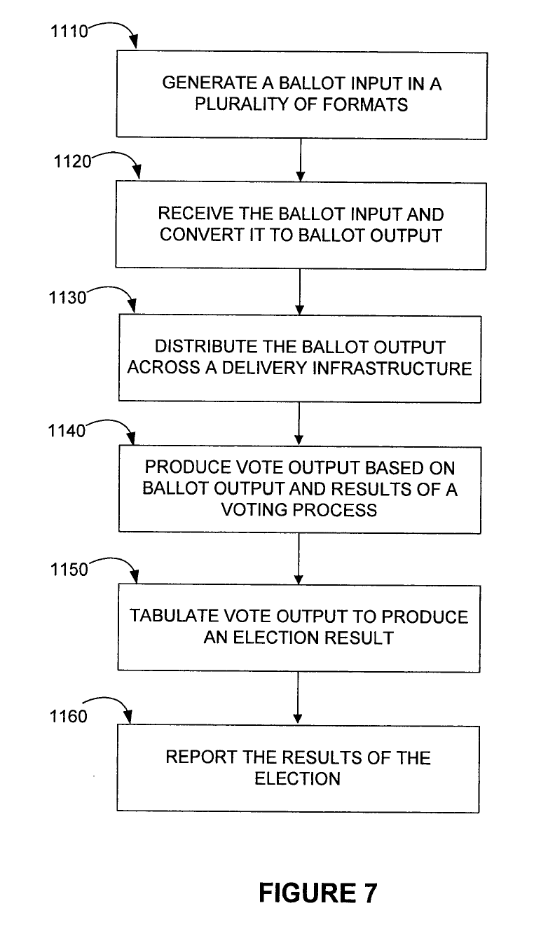

FIG. 7 is a diagram of an example process for utilizing a voting system according to an embodiment of the present invention. At step 1110, a setup module produces ballot input in a plurality of formats. The plurality of formats includes, for example, printed ballots, audio ballots, and a ballot input file. At step 1120, a conversion module receives the ballot input and converts it to ballot output. For example, the conversion module can convert an audio script to a plurality of sound files in different formats. Likewise, the conversion module can convert a ballot input file into the conversion output.

At step 1130, a loading module distributes the ballot output across a delivery infrastructure such as an electronic hub, a LAN, etc., to a plurality of precinct modules. At step 1140, the precinct modules facilitate an election process, by receiving the ballot output, allowing voters to vote, and then producing a vote output. In one embodiment, the vote output can reside on a memory device, for example, a portable transport memory. A tabulation module receives the vote output data from all of the precinct modules and at step 1150 tabulates the vote outputs to produce an election result. At step 1160, a reporting module receives the election result and reports the result of the election, for example, the reporting module can inform the public as to the winners and losers in the election or to print an audit trail to ensure the accuracy of the election.

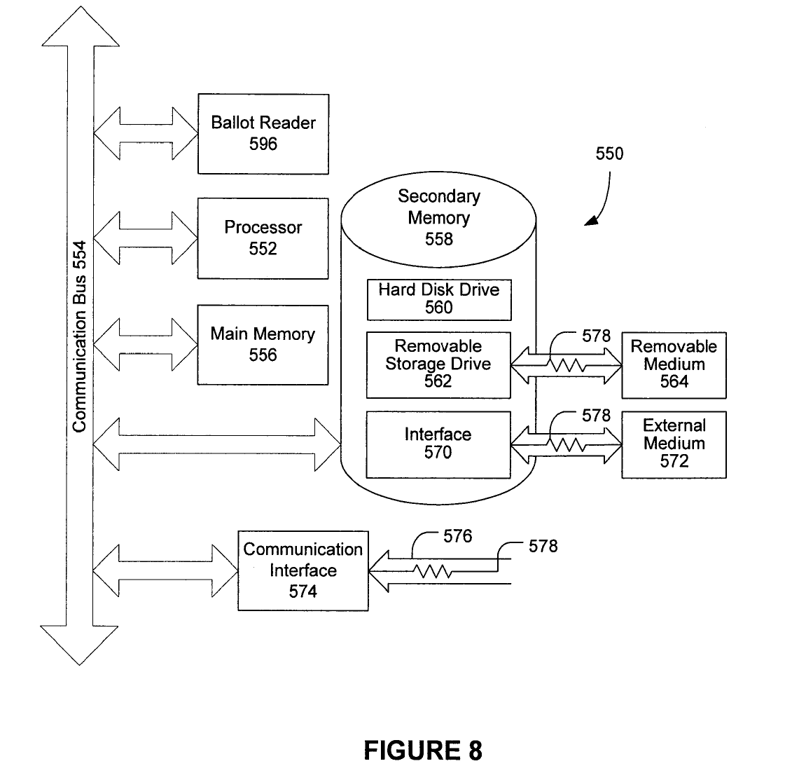

FIG. 8 is a block diagram illustrating an example computer system 550 that may be used in connection with various embodiments described herein. For example, the computer system 550 may be used in conjunction with the voting system 10 that includes a setup module, a conversion module, a loading module, a precinct module, a tabulation module, and a reporting module. The computer system 550 may also be used to implement the voting process and the system defined herein.

Vote data may also be stored in the data storage location through the use of the example computer system 550. The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

The ballot reader 596 is designed to take input in the form of a physical ballot and transform it into a digital election image that can be transferred via the communication bus 554 to the storage and other peripheral components of the computer system 550. For example, The voter can mark the ballot using a pen or a No. 2 pencil. Both sides of the ballot may be printed with candidate names and issues. Next to each is a hollow square, circle or oval to be filled in, or a head-and-tail of an arrow to be connected. Ballots may be entered into the ballot reader 596. For example, the ballot reader 596 can scan the ballot. The ballot reader 596 then reports to the computer system 550 the ballot positions marked by the voter.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Those of skill will appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular voting system and design constraints imposed on the overall system. Skilled persons can implement the described functionality in varying ways for each particular voting system, but such implementation decisions should not be interpreted as causing a departure from the scope of the invention. In addition, the grouping of functions within a module, block or step is for ease of description. Specific functions or steps can be moved from one module or block without departing from the invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A voting system comprising:
a setup module configured to generate a ballot input in a plurality of formats;
a conversion module configured to receive the ballot input and generate a converted ballot output;
a loading module configured to distribute the converted ballot output via a delivery infrastructure;
a plurality of precinct modules configured to receive the converted ballot output from the delivery infrastructure and produce vote outputs based on the converted ballot output and a voting process; and
a tabulation module configured to receive the vote outputs from each of the ballot precinct modules and aggregate the vote outputs to produce a result.

2. The system of claim 1 further comprising a reporting module configured to provide the result to a recipient.

3. The system of claim 1 wherein the plurality of formats comprise extensible markup language, an audio script, or a formatted document.

4. The system of claim 1 wherein the delivery infrastructure comprises an electronic hub between the loading module and the plurality of precinct modules.

5. The system of claim 1 wherein the precinct module further comprises an input module configured to receive the converted ballot output by scanning or reading.

6. The system of claim 1 wherein the precinct module further comprises an output module comprising a liquid crystal display.

7. The system of claim 1 wherein the precinct module further comprises an input module comprising an Americans with Disabilities Act compliant keyboard.

8. The system of claim 1 wherein the precinct module further comprises an input module comprising a ballot card reader.

9. The system of claim 1 further comprising a language module configured to enable the production of vote output based on the converted ballot output in a plurality of languages.

10. The system of claim 1 wherein the conversion module is configured to receive the ballot input as an audio script and to generate the converted ballot output as a sound file in a plurality of formats.

11. An election conversion method comprising:
receiving an audio file from an election setup module;
receiving a ballot input file from the election setup module;
transforming the audio file into one or more sound files in a plurality of formats;
accessing one or more fields in the ballot input file;
generating a conversion output suitable for a precinct module using the one or more fields; and
adding the one or more sound files to the conversion output.

12. The method of claim 11 wherein the step of receiving a ballot input file further comprises receiving a ballot input file written in extensible markup language.

13. The method of claim 11 wherein the plurality of formats include waveform audio files, motion pictures expert group files (“MPEG”), audio video interleave files, or MPEG layer 3 files.

14. The method of claim 11 wherein the one or more fields in the ballot input file are arranged hierarchically from a root node and have a plurality of levels.

15. The method of claim 14 wherein one of the levels includes a ballot style entry for formatting the ballot for the precinct module.

16. The method of claim 14 wherein one or more of the levels includes a Boolean value.

17. The method of claim 11 wherein the step of accessing one or more fields in the ballot input file further comprises:
determining a plurality of the fields of the ballot input file that a precinct module needs; and
splitting the plurality of fields into a plurality of definition files for the precinct module.

18. The method of claim 18 further comprising applying an encryption key to data associated with the plurality of definition files.

19. A computer readable medium having stored thereon one or more sequences of instructions for causing one or more microprocessors to perform the steps for implementing a voting method, the steps comprising:
generating a ballot input in a plurality of formats;
receiving the ballot input;
converting the ballot input to a converted ballot output;
distributing the converted ballot output via a delivery infrastructure;
receiving the converted ballot output from the delivery infrastructure;
producing vote outputs based on the converted ballot output and a voting process;
receiving the vote outputs; and
aggregating the vote outputs to produce a result.

20. The computer readable medium having stored thereon one or more sequences of instructions for causing one or more microprocessors to perform the steps for implementing a voting method according to claim 19, further comprising providing the result to a recipient.

21. The computer readable medium having stored thereon one or more sequences of instructions for causing one or more microprocessors to perform the steps for implementing a voting method according to claim 19, wherein the plurality of formats comprise extensible markup language, an audio script, or a formatted document.

22. The computer readable medium having stored thereon one or more sequences of instructions for causing one or more microprocessors to perform the steps for implementing a voting method according to claim 19, wherein the delivery infrastructure comprises an electronic hub and wherein the step of distributing further comprises distributing the converted ballot output via the electronic hub.

23. The computer readable medium having stored thereon one or more sequences of instructions for causing one or more microprocessors to perform the steps for implementing a voting method according to claim 19, wherein the step of receiving further comprises scanning the converted ballot output.

24. The computer readable medium having stored thereon one or more sequences of instructions for causing one or more microprocessors to perform the steps for implementing a voting method according to claim 19, wherein the step of producing further comprises providing a liquid crystal display touch screen.

25. The computer readable medium having stored thereon one or more sequences of instructions for causing one or more microprocessors to perform the steps for implementing a voting method according to claim 19, wherein the step of producing further comprises providing an Americans with Disabilities Act compliant keyboard.

26. The computer readable medium having stored thereon one or more sequences of instructions for causing one or more microprocessors to perform the steps for implementing a voting method according to claim 19, wherein the step of producing further comprises enabling the voting process in a plurality of languages.

27. The computer readable medium having stored thereon one or more sequences of instructions for causing one or more microprocessors to perform the steps for implementing a voting method according to claim 19, wherein the step of converting further comprises:
receiving the ballot input as an audio script; and
generating a sound file in a plurality of formats from the audio script.

28. A precinct module comprising:
a touch screen for receiving input and providing a visual output to a voter;
a controller including a ballot card reader and an Americans with Disabilities Act (ADA) unit, wherein the ballot card reader can receive a first ballot card as input and the controller can tabulate data on the first ballot card and display first results on the touch screen and wherein the ADA unit can receive input and produce a second ballot card as output and wherein the ballot card reader can receive the second ballot card as input and the controller can tabulate data on the second ballot card and present second results via an audio interface; and
a memory module including a transport memory and a fixed memory wherein data on the first and the second ballot cards are stored on both the transport memory and the fixed memory.

29. The precinct module of claim 28 wherein the ADA unit comprises an ADA compliant keyboard.
